(19) United States
(12) Patent Application Publication
(10) Pub. No.: US 2022/0336959 A1
(43) Pub. Date: Oct. 20, 2022

(54) ANTENNA ASSEMBLY HAVING RESONANT CIRCUIT SPANNING GROUND PLANE SLOT

(71) Applicant: Hewlett-Packard Development Company, L.P., Spring, TX (US)

(72) Inventors: Juhung Chen, Taipei City (TW); Chin-Hung Ma, Taipei City (TW); Po Chao Chen, Taipei City (TW); Hung-Wen Cheng, Taipei City (TW)

(73) Assignee: Hewlett-Packard Development Company, L.P., Spring, TX (US)

(21) Appl. No.: 17/641,878

(22) PCT Filed: Nov. 1, 2019
(86) PCT No.: PCT/US2019/059317

§ 371 Date: Mar. 10, 2022

(51) Int. Cl. H01Q 13/10; H01Q 1/48; H01Q 9/42

(52) U.S. Cl. CPC H01Q 13/103; H01Q 1/48; H01Q 9/42

(57) ABSTRACT

An antenna assembly includes a ground plane, a radiator, and a resonant circuit. The ground plane has a slot with an open end. The radiator spans the slot and has a shape configured to radiate electromagnetic energy at a first frequency and at a second frequency. The resonant circuit spans the slot in parallel with the radiator and is positioned nearer the open end than an opposite end of the slot.

### BACKGROUND

Electronic devices, including laptop and notebook computers, smartphones, tablet computing devices, and other types of electronic devices, commonly include wireless network connectivity capability. For example, such devices may have wireless local-area network (WLAN) capability to connect to networks like the Internet using Wi-Fi technology. The WLAN capability may permit an electronic device to communicate over multiple frequency bands, such as the 2.4 gigahertz (GHz) and 5 GHz frequency bands. Electronic devices having these and other types of wireless network connectivity capability include antennas, which are often internal antennas, by which the devices wirelessly transmit and receive data.

### BRIEF DESCRIPTION OF THE DRAWINGS

FIG. 1A is a top view diagram of an example open-ended slot antenna assembly including a resonant circuit. FIG. 1B is a top view diagram of the ground plane of the example antenna assembly. FIG. 1C is a side view diagram of the example antenna assembly.

FIGS. 2A and 2B are top view diagrams depicting example wireless radiation at a first frequency in relation to a ground plane of an example open-ended slot antenna assembly including a resonant circuit, when the open end of the slot in the ground plane is respectively uncovered and covered by an external conductive element.

FIGS. 3A and 3B are top view diagrams depicting example wireless radiation at a second frequency in relation to a ground plane of an example antenna assembly including a resonant circuit, when an open end of a slot in the ground plane is respectively uncovered and covered by an external conductive element.

FIG. 4A is a diagram of an example electrical circuit modeling a slot of a ground plane of an example antenna assembly in relation to a resonant circuit of the antenna assembly. FIG. 4B is a diagram of the example electrical circuit in an example implementation in which the resonant circuit has an inductance and a capacitance in parallel.

FIG. 5 is a block diagram of an example antenna assembly including a resonant circuit.

FIG. 6 is a block diagram of an example electronic device including an antenna assembly having a resonant circuit, in which an enclosure of the electronic device serves as the ground plane of the antenna assembly.

### DETAILED DESCRIPTION

As noted in the background section, electronic devices commonly include wireless network connectivity capability, such as WLAN capability, by which the devices wirelessly transmit and receive data over multiple frequency bands, such as the 2.4 gigahertz (GHz) and 5 GHz frequency bands, via internal antennas. Laptop and notebook computers, smartphones, and tablet computing devices, as well as other types of electronic devices, can employ open-ended slot antennas integrated with their enclosures. In an open-ended slot antenna, a radiator spans an open-ended slot within a ground plane. The enclosure of an electronic device can thus serve as the ground plane, with the open-ended slot formed within the enclosure.

An electronic device wirelessly transmits data using its open-ended slot antenna at a specified transmission power. In general, the higher the transmission power applied to the antenna, the stronger the resulting wireless signal is that emanates from the antenna. Regulating agencies govern the maximum transmission power for different frequency bands, on a per-country or per-region basis, to minimize interference with other devices using the same frequency bands, and to maintain user safety even when the devices are placed closed to the end users' bodies for extended periods of time.

For electronic devices that are used near people, including laptop and notebook computers and tablet computing devices, and especially smartphones, another issue comes into play in controlling the maximum transmission power at which the devices can drive their open-ended slot antennas. This issue is external specific absorption rate (SAR), which is the measure of the rate at which energy is absorbed by the human body when exposed to a radio frequency (RF) electromagnetic field. An open-ended slot antenna integrated within the enclosure of an electronic device may result in an external SAR exceeding the regulation-governed maximum, particularly when the enclosure is held or handled during wireless transmission, as is often the case with smartphones and other types of electronic devices.

For example, a user may hold an electronic device with an open-ended slot antenna in such a way that he or she comes into contact with the open end of the slot, by placing a finger or another part of the body against the slot's open end. The conductive nature of the human body can in turn effectively cause the antenna to operate in a closed slot mode instead of an open slot mode for a certain frequency band or bands. The spatial location at which maximum radiation occurs for such a frequency band correspondingly moves towards the now effectively closed slot end, increasing external SAR. To mitigate this issue, the transmission power at which data is wirelessly transmitted is usually decreased, but this is problematic because wireless performance is resultantly degraded in range, speed, or both.

Techniques described herein ameliorate this issue, permitting transmission power to be maintained while still ensuring that external SAR is below the regulation-permitted maximum even when a user of an electronic device comes into contact with the open end of the slot of the device's enclosure. Besides the radiator that spans the slot of the enclosure, which acts as the antenna's ground plane as noted above, the antenna includes a resonant circuit that spans the slot in parallel with the radiator and is positioned nearer the slot's open end than the opposite end of the slot.

The resonant circuit minimizes total impedance across the slot at a given frequency band, causing the antenna to operate to operate in a closed slot mode at this frequency regardless of whether an external conductive element, like a part of the user's body, covers the antenna slot's open end. However, the resonant circuit causes the spatial location at which maximum radiation at the frequency band in question occurs away from the open end, even if an external conductive element covers the antenna slot's open end. As such, the resonant circuit maintains external SAR below a threshold SAR at the desired frequency band even when an external conductive element covers the open end, without having to reduce transmission power driving the radiator.

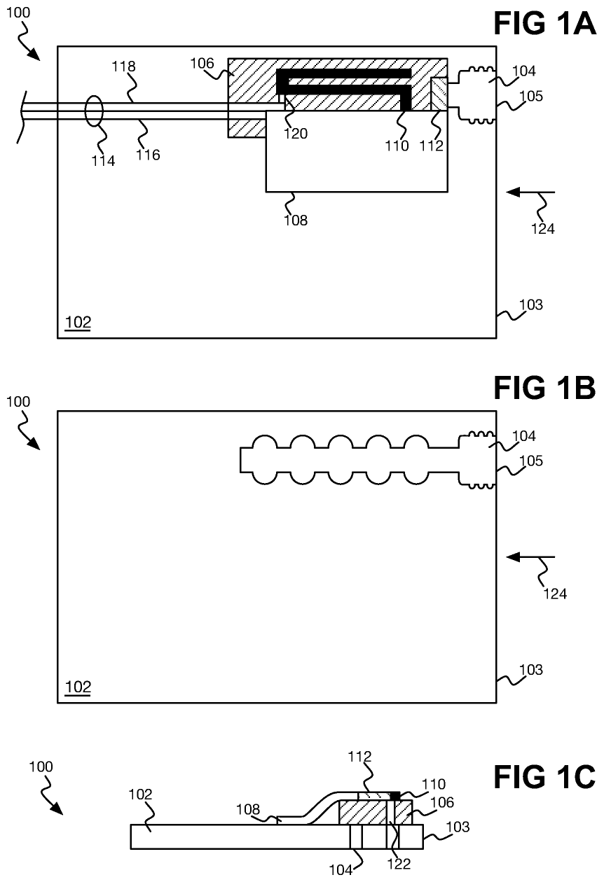

FIG. 1A shows a top view of an example antenna assembly 100, FIG. 1B shows a top view of just a ground plane 102 of the antenna assembly 100, and FIG. 1C shows a side view of the antenna assembly 100 as viewed in the direction of the arrow 124 in FIGS. 1A and 1B. The ground plane 102 can be modeled as an infinite ground plane, but in actuality just approximates an infinite ground plane. The ground plane 102 has a slot 104 with an open end 105, at an edge 103 of the plane 102. The slot 104 may not extend completely through the ground plane 102, as depicted in FIG. 1C.

As depicted in FIG. 1B, the open-ended slot 104 of the ground plane 102 has a particular shape, but in other implementations can have a different shape. The overall shape of the slot 104, in which the slot 104 is wider but shorter at the open end 105 and then narrower but longer away from the end 105, has been found to be particularly suited for an antenna assembly 100 in which wireless data communication occurs at 2.4 and 5 GHz WLAN frequency bands. The “bumps” or round “ridges” along the length of the slot 104 have been found to provide easier fabrication of the slot 104 within the ground plane 102 when the plane 102 is anodized aluminum, as can be the case with laptop and notebook computer and smartphone enclosures.

Besides the ground plane 102, the antenna assembly 100 includes a dielectric layer 106 disposed on a surface of the ground plane 102. In the case in which the ground plane 102 is formed within an enclosure of an electronic device like a laptop or notebook computer or a smartphone, this surface is the interior surface of the enclosure. The dielectric layer 106 may be a circuit board, for instance, and is electrically insulative.

The antenna assembly 100 includes a radiator 110 disposed on the dielectric layer 106, which is conductive and may be formed as an electrical trace. The radiator 110 spans the slot 104. As depicted in FIG. 1A, the radiator 110 has a particular configuration, including a particular shape and size, but in other implementations can have a different configuration. The configuration of the radiator 110 as shown has been found to be particularly suited for an antenna assembly 100 in which wireless data communication occurs at 2.4 and 5 GHz WLAN frequency bands. More generally, the radiator 110 is configured to radiate electromagnetic energy at first and second frequencies, which can respectively be a frequency in a 2.4 GHz WLAN frequency band and a frequency in a 5 GHz WLAN frequency band.

The antenna assembly 100 includes a resonant circuit 112 disposed on the dielectric layer 106, and which spans the slot 104. The resonant circuit 112 is positioned nearer the open end 105 of the slot 104 than the opposite end of the slot 104, but not at the open end 105 of the slot 104 flush with the edge 103 of the ground plane 102. The resonant circuit 112 may also be referred to as an LC circuit due to its having an inductance and a capacitance, or as a tank circuit or tuned circuit. The resonant circuit 112 is tuned to a particular frequency and thus can act as a band-pass or band-stop filter at this frequency. In the example antenna assembly 100, the resonant circuit 112 is tuned to the first frequency at which the radiator 110 is configured to radiate electromagnetic energy, such as a frequency in a 2.4 GHz WLAN frequency band.

The antenna assembly 100 includes an electrical ground 108 conductively connected to the radiator 110 and the resonator circuit 112. In the example antenna assembly 100, the electrical ground 108 is an adhesive ground foil affixed to the ground plane 102 and the dielectric layer 106, as may be the case in an implementation in which an enclosure of a laptop or notebook computer acts as the ground plane 102. In other implementations, the electrical ground 108 may be a ground screw conductively connected to the radiator 110 and the resonator circuit 112, as may be the case in an implementation in which an enclosure of a smartphone acts as the ground plane 102. The electrical ground 108 may be another type of ground as well.

The antenna assembly 100 includes a cable 114 having conductors 116 and 118. As shown in FIG. 1A, the two conductors 116 and 118 may be disposed side-by-side (but insulated from one another), but in another implementation, the cable 114 can be may be a coaxial cable in which the conductor 116 is the outside conductor and the conductor 118 is the inside conductor. The conductor 116 conductively connects the electrical ground 108 (and thus the ground plane 102, the radiator 110, and the LC circuit 112) to an overall system ground of the device of which the antenna assembly 100 is a part. The conductor 118 conductively connects to the radiator 110, via a trace 120; the other end of the conductor 116 connects to the antenna driving circuit of the device of which the antenna assembly 100 is a part.

The antenna assembly 100 includes a conductive via 122 through the dielectric layer 106, per FIG. 1C, which conductively connects the resonant circuit 112 to the ground plane 102, and thus to the enclosure of an electronic device in the case in which the enclosure is acting as the ground plane 102. Because the radiator 110 and the resonant circuit 112 are both connected to the electrical ground 108, the conductive via 122 therefore indirectly effectively connects the radiator 110 to the ground plane 102, too. In another implementation, however, there may be a separate conductive via through the dielectric layer 106 that conductively connects the radiator 110 to the ground plane 102, or the via 122 may directly connect the radiator 110, instead of the resonant circuit 112, to the ground plane 102.

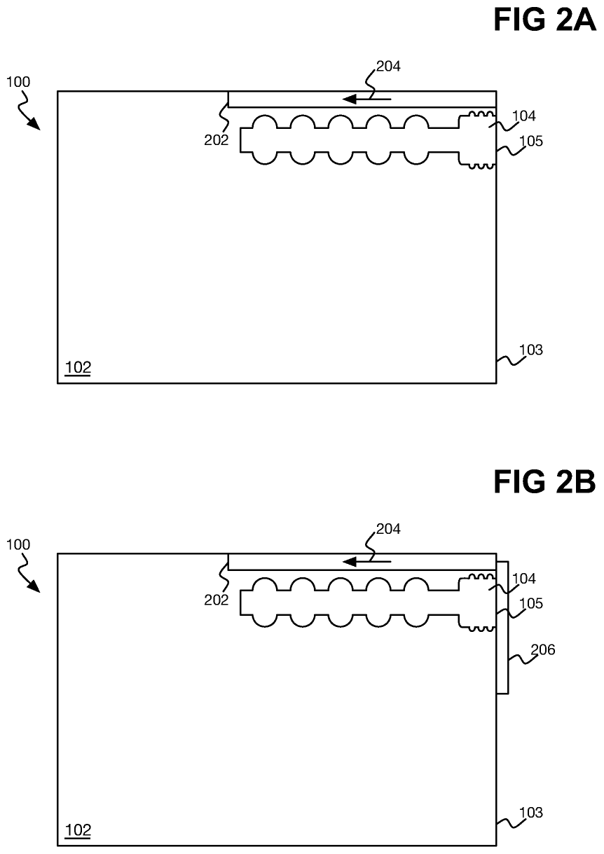

FIGS. 2A and 2B show example wireless radiation of the antenna assembly 100 at a first frequency within a 2.4 GHz WLAN frequency band, in relation to the open-ended slot 104 of the ground plane 102. The other components of the antenna assembly 100 are not depicted in FIGS. 2A and 2B for illustrative clarity. In FIG. 2A, there is no external conductive element covering the end 105 of the slot 104 at the edge 103 of the ground plane 102. By comparison, in FIG. 2B, an external conductive element 206 covers the end 105 of the slot 104 of the ground plane 102. The external conductive element 206 may be a part of the body of a user holding an electronic device, in the case in which the enclosure of the device acts as the ground plane 102 and thus includes the slot 104.

In FIG. 2A, the wireless radiation of the antenna assembly 100 at the first frequency occurs within a region 202 adjacent to and running alongside the open-ended slot 104. The radiation is directed inwards from the edge 103 of the ground plane 102, per the arrow 204. The spatial location at which maximum radiation occurs at the first frequency is within the region 202. In FIG. 2B, the wireless radiation at the first frequency still occurs within the region 202 and is directed inwards per the arrow 204. However, the magnitude of the wireless radiation is less when the end 105 of the slot 104 is covered by the external conductive element 206 in FIG. 2B as compared to when it is not in FIG. 2A.

In FIGS. 2A and 2B, external SAR due to wireless radiation at the first frequency may not be an issue. For instance, in FIG. 2B, because wireless radiation decreases in magnitude (i.e., intensity) as compared to FIG. 2A, external SAR may not be an issue. In both FIGS. 2A and 2B, the region 202 at which wireless radiation occurs is away from the outside edge 103 of the ground plane 102. In the case in which the enclosure of an electronic device acts as the ground plane 102 and the external conductive element 206 is a part of the body of the user holding the device, no part of the body is immediately adjacent to or in contact with the region 202. Further, the presence of the resonant circuit 112 within the antenna assembly 100, per FIGS. 1A-1C as has been described, does not affect the wireless radiation at the first frequency.

That is, the wireless radiation as shown in FIGS. 2A and 2B would be similar if not identical if the resonant circuit 112 were absent from the antenna assembly 100. This is because the resonant circuit 112 is tuned to the first frequency. As such, total impedance across the slot 104 is maximized at the first frequency when the resonant circuit 112 is present. Adding the resonant circuit 112 thus does not affect wireless radiation at the first frequency, because tuning the circuit 112 to the first frequency maximizes total impedance across the slot 104 at this frequency, which means adding the circuit 112 does not create a conductive path across the slot 104 at the first frequency.

The antenna assembly 100 therefore operates in an open slot mode at the first frequency, regardless of whether the external conductive element 206 covers the end 105 of the slot 104 as in FIG. 2B, or does not as in FIG. 2A. That the antenna assembly 100 operates in the open slot mode at the first frequency means that there is no direct electrical path across the slot 104 within the ground plane 102 at the first frequency. The resonant circuit 112 does not create such a direct electrical path because it is tuned to the first frequency, as noted above.

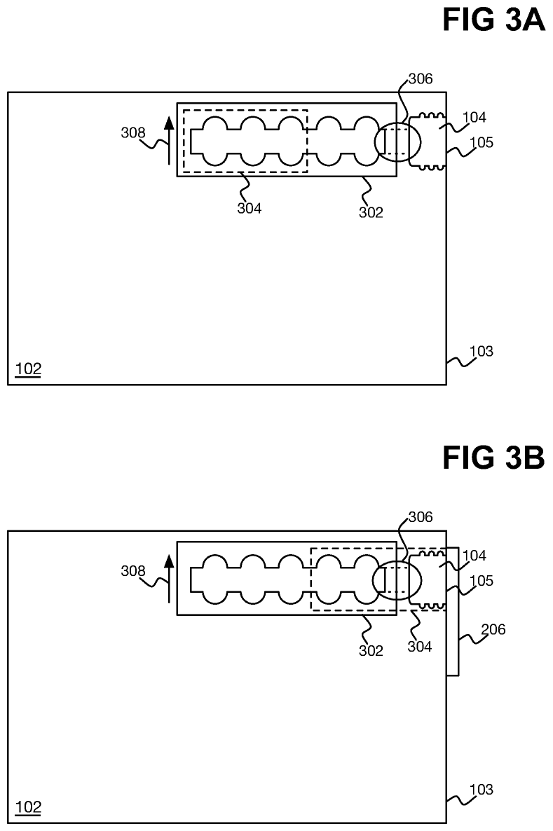

FIGS. 3A and 3B show example wireless radiation of the antenna assembly 100 at a second frequency within a 5 GHz WLAN frequency band, in relation to the open-ended slot 104 of the ground plane 102. The other components of the antenna assembly 100 are not depicted in FIGS. 3A and 3B for illustrative clarity. In FIG. 3A, there is no external element covering the end 105 of the slot 104 at the edge 103 of the ground plane 102. By comparison, in FIG. 3B, the external conductive element 206 covers the end 105 of the slot 104 of the ground plane 102.

In FIG. 3A, wireless radiation of the antenna assembly 100 at the second frequency occurs within a region 302 encompassing the narrow part of the open-ended slot 104. The radiation is directed across the slot 104, upwards, per the arrow 308. The spatial location at which maximum radiation occurs at the second frequency is within the region 302. By comparison, if the resonant circuit 112 of FIGS. 1A-1C were not present within the antenna assembly 100, wireless radiation at the second frequency would occur within a region 304 encompassing a portion of the narrow part of the slot 104, with the spatial location at which maximum radiation occurs at this frequency again being within the region 304.

This difference is due to the resonant circuit 112 minimizing total impedance across the open-ended slot 104 at the second frequency, which creates a conductive path across the slot 104 at the second frequency where the resonant circuit 112 is located, corresponding to the region 306 in FIG. 3A. The antenna assembly 100 therefore operates in a closed slot mode at the second frequency due to the resonant circuit 112, resulting in the region 302 at which wireless radiation occurs at the second frequency. By comparison, if the resonant circuit 112 were absent, the antenna assembly 100 would operate in an open slot mode, resulting in the region 304 at which wireless radiation occurs at the second frequency.

In FIG. 3B, the wireless radiation at the second frequency remains the same when the resonant circuit 112 is present, occurring within the region 302 and directed inwards per the arrow 308, even though the external conductive element 206 now covers the end 105 of the slot 104. Because the resonant circuit 112 effectively shorts the slot 104 where the circuit 112 is located, corresponding to the region 306 in FIG. 3B, the fact that the external conductive element 206 shorts the slot 104 at the open end 105 does not matter, since it is further away from the narrow part of the slot 104 than the resonant circuit 112 is. The antenna assembly 100 thus operates in the closed slot mode in FIG. 3B no differently than it does in FIG. 3A, except that the magnitude of the wireless radiation may be slightly less when the end 105 of the slot 104 is covered by the external conductive element 206 in FIG. 3B as compared to when it is not in FIG. 3A.

By comparison, if the resonant circuit 112 were not present within the antenna assembly 100, the region 304 at which wireless radiation at the second frequency would occur moves outwards in FIG. 3B, adjacent to the external conductive element 206 covering the end 105 of the slot 104, as compared to FIG. 3A when no external conductive element covers the end 105. If the resonant circuit 112 were absent, there is no short at the region 306 between the narrow and wide parts of the slot 104 as there is when the circuit 112 is present. Without the resonant circuit 112, the antenna assembly 100 would operate in the closed slot mode in FIG. 3B, though, due to the external conductive element 206 shorting the slot 104 at its end 105, as compared to in the open slot mode in FIG. 3A when no conductive element covers the end 105 of the slot 104.

In FIGS. 3A and 3B, external SAR due to wireless radiation at the second frequency is not an issue when the resonant circuit 112 is present. This is because the region 302 at which wireless radiation occurs at the second frequency is away from the outside edge 103 of the ground plane 102, regardless of whether the external conductive element 206 covers the end 105 of the slot 104. That is, no reduction in the transmission power driving the radiator 110 of FIGS. 1A-1C is necessary to maintain the external SAR below a threshold SAR at the second frequency when the external conductive element 206 covers the end 105 of the slot 104 in FIG. 3B as compared to when no conductive element covers the end 105 in FIG. 3A.

By comparison, if the resonant circuit 112 were absent, external SAR due to wireless radiation at the second frequency may become an issue in FIG. 3B. This is because the region 302 at which wireless radiation occurs at the second frequency is flush with the outside edge 103 of the ground plane 102 when the external conductive element 206 covers the end 105 of the slot 104. A reduction in the transmission power driving the radiator 110 of FIGS. 1A-1C may be necessary to maintain the external SAR below a threshold at the second frequency when the external conductive element 206 covers the end 105 of the slot 104 in FIG. 3B as compared to when no conductive element covers the end 105 in FIG. 3A in this case. Adding the resonant circuit 112 to the antenna assembly 100 thus ensures that wireless communication performance is not impaired in FIG. 3B as compared to FIG. 3A due to reduced transmission power.

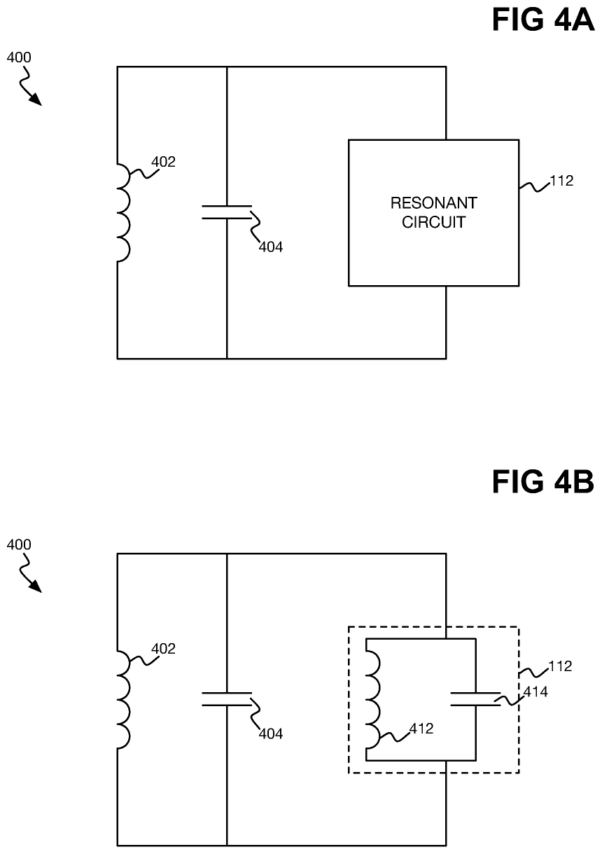

FIG. 4A is a diagram of an example electrical circuit 400 modeling the slot 104 within the ground plane 102, in relation to the resonant circuit 112. FIG. 4B is a diagram of the electrical circuit 400 in an example implementation in which the resonant circuit 112 has an inductance 412 and a capacitance 414 in parallel. The slot 104 similarly is modeled as having an inductance 402 and a capacitance 404 in parallel with one another.

The inductance 402 and the capacitance 404 of the slot 104 are not discrete electrical components like an inductor and a capacitor. Rather, the inductance 402 and the capacitance 404 are the inductance and the capacitance that the slot 104 has in the radiation path of electromagnetic energy across the slot 104. The inductance 402 and the capacitance 404 may be respectively represented as L_{S} and C_{S}, and are in parallel with one another. The resonant circuit 112 in turn is in parallel with the inductance 402 and the capacitance 404 of the slot 104.

In the example implementation of FIG. 4B, the inductance 412 and the capacitance 414 of the resonant circuit 112 may be respectively represented as L_{R} and C_{R}, and are in parallel to one another. The resonant circuit 112 may include one inductor, such that the inductance 412 is the inductance of this inductor. The resonant circuit 112 may include more than one inductor, such that the inductance 412 is the sum of the inductances of the inductors.

Similarly, the resonant circuit 112 may include one capacitor, such that the capacitance 412 is the capacitance of this capacitor. The resonator circuit 112 may include more than one capacitor, such that the capacitance 412 is the sum of the capacitances of the capacitors. In implementations other than that of FIG. 4B, the resonant circuit 412 may include inductor(s) and capacitor(s) in series with one another, or in configurations more complex than a parallel or series configuration, including pi-type configurations. Furthermore, distributed circuits may be used to replace lump inductor(s) and capacitor(s).

The total inductance across the slot 104 may be represented as L_{T}, and the total capacitance across the slot 104 may be represented as C_{T}. The total inductance is equal to

$$\frac{1}{1 / {L}_{S} + 1 / {L}_{R}} .$$

Assuming that the inductance 402 of the slot 104 is much greater than the inductance 412 of the resonant circuit 112 (i.e., L_{S}>>L_{R}), the total inductance LT approximates the inductance 412 of the resonant circuit 112 (i.e., L_{T}≅L_{R}). The total capacitance across the slot 104 is equal to C_{S}+C_{R}, where C_{S} is the capacitance 404 of the slot 104 and C_{R} is the capacitance 414 of the resonant circuit 112 as noted above.

The resonant frequency across the slot 104 is

$$\frac{1}{2 π \sqrt{{L}_{T} \cdot {C}_{T}}} .$$

However, because the total inductance L_{T} approximates L_{R} and because the total capacitance C_{T} is equal to the sum of C_{S} and C_{R}, the resonant frequency across the slot 104 is approximately

$$\frac{1}{2 π \sqrt{{L}_{R} \cdot ( {C}_{S} + {C}_{R} )}} .$$

The capacitance 404 of the slot 104, C_{S}, is known. The inductance 412 and the capacitance 414 of the resonant circuit 112, L_{R} and C_{R}, can therefore be selected under two constraints.

The first constraint is that the resonant frequency across the slot 104 is equal to the first frequency, so that the resonant circuit 112 is operative at the first frequency. The second constraint is to maximize the total inductance L_{T} across the slot 104 at the first frequency so that the resonant circuit 112 is operative at the first frequency specifically as a parallel LC tank resonating as an open circuit, since inductive impedance increases with frequency whereas capacitive impedance decreases with frequency. Therefore, L_{R} and C_{R} are selected so that the resonant frequency is equal to the first frequency and so that L_{R} is as large as possible.

For example, the capacitance 404 of the slot 104, C_{S}, may be about 0.3 picofarads (pF), and the first frequency may be 2.43 GHz. Therefore, the inductance 412, LR, and the capacitance, C_{R}, of the resonant circuit 112 may be selected as 3.3 nanohenries (nH) and 1 pF, respectively. The total inductance L_{T} across the slot at the resonant frequency of 2.43 GHz thus approximates 3.3 nH, which is a relatively large inductance. As such, at the resonant frequency of 2.43 GHz, total impedance across the slot 104 is maximized. Since the resonant circuit 112 is operative as a band-stop filter at this frequency, total impedance across the slot 104 at other frequencies, such as a second frequency within the 5 GHz WLAN band, is minimized.

Therefore, at the first frequency, such as at 2.43 GHz, the resonant circuit 112 is or approaches an open circuit (i.e., a band-stop filter). By comparison, at the second frequency, such as at 5 GHz, the resonant circuit 112 is or approaches a closed or short circuit (i.e., a band-pass filter). The resulting slot antenna assembly 100 thus operates as an open-slot antenna, similar to a planar inverted F antenna (PIFA), at the first frequency (e.g., 2.43 GHz), because the resonant circuit 112 is a band-stop filter at this frequency. By comparison, at the second frequency (e.g., 5 GHz), the resulting slot antenna assembly 100 operates as a closed-slot antenna, because the resonant circuit 112 is a band-pass filter at this frequency.

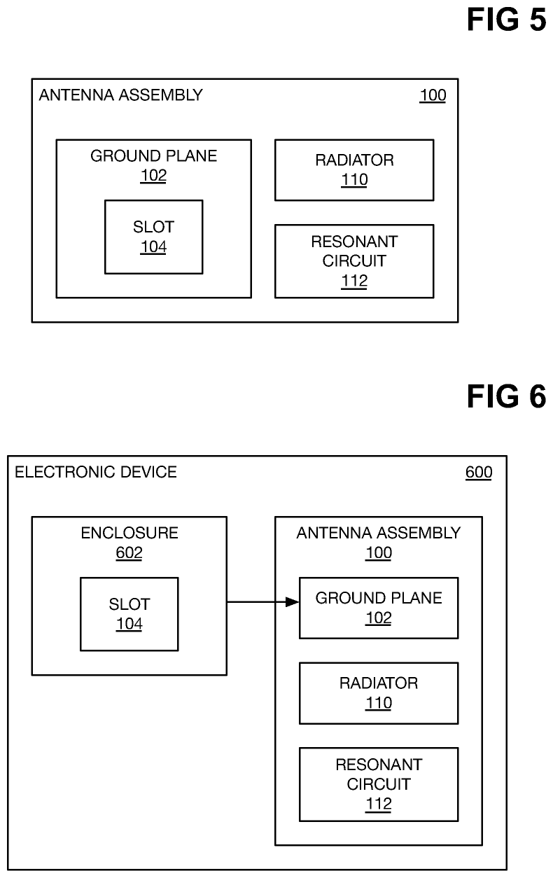

FIG. 5 shows a block diagram of the example antenna assembly 100. The antenna assembly 100 includes a ground plane 102 having an open-ended slot 104. The antenna assembly 100 includes a radiator 110 spanning the slot 104 and that is configured to radiate electromagnetic energy at a first frequency and at a second frequency. The antenna assembly 100 includes a resonant circuit 112 spanning the slot 104 in parallel with the radiator 110 and which is positioned nearer the open end than an opposite end of the slot 104.

FIG. 6 shows a block diagram of an example electronic device 600. The electronic device 600 includes an enclosure 602 having an open-ended slot 104. The device 600 includes an antenna assembly 100 having a radiator 110 and a resonator circuit 112 in parallel with one another and which span the slot 104. The radiator 110 is configured to radiate electromagnetic energy at first and second frequencies, and the resonator circuit 112 is positioned nearer the open end than an opposite end of the slot 104. The enclosure 602 acts as a ground plane 102 of the antenna assembly 100.

Techniques have been described herein to maintain external SAR for a slot antenna below a threshold at a desired frequency band even when an external conductive element covers the open end of the antenna slot. A resonant circuit is placed in parallel with the radiator of the antenna across the slot. The resonant circuit minimizes total impedance across the slot at the desired frequency band, causing the antenna to operate to operate in a closed slot mode at this frequency band regardless of whether an external conductive element covers the antenna slot's open end. As such, antenna performance at the frequency band can be maintained even when an external conductive element covers the end of the slot, which would other necessitate decreasing transmission power at the frequency band.

The techniques have been described herein in relation to an example implementation in which the first and the second frequencies are both within WLAN frequency bands. For example, the first frequency has been described as being within the 2.4 GHz WLAN frequency band, and the second frequency has been described as being within the 5 GHz WLAN frequency band. However, in other implementations, the first and second frequencies can be in different frequency bands. Example such frequency bands include wireless wide-area network (WWAN) frequency bands, 3G, 4G, LTE, and 5G mobile network frequency bands, as well as other frequency bands.

We claim:

1. An antenna assembly comprising:
a ground plane having a slot with an open end;
a radiator spanning the slot and is configured to radiate electromagnetic energy at a first frequency and at a second frequency; and
a resonant circuit spanning the slot in parallel with the radiator and positioned nearer the open end than an opposite end of the slot.

2. The antenna assembly of claim 1, wherein the resonant circuit minimizes total impedance across the slot at the second frequency and maximizes the total impedance across the slot at the first frequency.

3. The antenna assembly of claim 1, wherein the resonant circuit causes the antenna assembly to operate in an open slot mode at the first frequency and in a closed slot mode at the second frequency regardless of whether an external conductive element covers the open end of the slot.

4. The antenna assembly of claim 1, wherein the resonant circuit causes a spatial location of the antenna assembly at which maximum radiation at the second frequency occurs away from the open end of the slot regardless of whether an external conductive element covers the open end of the slot.

5. The antenna assembly of claim 1, wherein the resonant circuit maintains a external specific absorption rate (SAR) below a threshold SAR at the second frequency when an external conductive element covers the open end of the slot without having to reduce transmission power driving the radiator.

6. The antenna assembly of claim 1, wherein the resonant circuit has an inductance and a capacitance selected to tune a resonant frequency across the slot to the first frequency.

7. The antenna assembly of claim 1, wherein the resonant circuit comprises an inductance in parallel with a capacitance, a total inductance across the slot approximating the inductance of the resonant circuit, a total capacitance across the slot including the capacitance of the resonant circuit.

8. The antenna assembly of claim 1, wherein the first frequency is within a 2.4 gigahertz (GHz) wireless local-area network (WLAN) band, and the second frequency is within a 5 GHz WLAN band.

9. An electronic device comprising:
an enclosure having a slot with an open end; and
an antenna assembly having a radiator and a resonator circuit in parallel with one another and spanning the slot, the radiator configured to radiate electromagnetic energy at first and second frequencies, the resonator circuit positioned nearer the open end than an opposite end of the slot,
wherein the enclosure acts as a ground plane of the antenna assembly.

10. The electronic device of claim 9, wherein the antenna assembly further has:
a dielectric layer disposed on an interior surface of the enclosure and on which the radiator and the resonator circuit are disposed; and
a conductive via through the dielectric layer to conductively connect the radiator and the resonator circuit to the enclosure; and
an electrical ground conductively connected to the radiator and the resonator circuit.

11. The electronic device of claim 10, further comprising:
a cable having a first conductor conductively connected to the radiator and a second conductor conductively connected to the electrical ground.

12. The electronic device of claim 9, wherein the first frequency is within a 2.4 gigahertz (GHz) wireless local-area network (WLAN) band, and the second frequency is within a 5 GHz WLAN band.

13. The electronic device of claim 9, wherein the resonant circuit reduces total impedance across the slot at the second frequency and maximizes the total impedance across the slot at the first frequency,
and wherein the resonant circuit causes the antenna assembly to operate in an open slot mode at the first frequency and in a closed slot mode at the second frequency regardless of whether an external conductive element covers the open end of the slot.

14. The electronic device of claim 9, wherein the resonant circuit causes a spatial location of the antenna assembly at which maximum radiation at the second frequency occurs away from the open end of the slot regardless of whether an external conductive element covers the open end of the slot,
and wherein the resonant circuit maintains a external specific absorption rate (SAR) below a threshold SAR at the second frequency when the external conductive element covers the open end of the slot without having to reduce transmission power driving the radiator.

15. The electronic device of claim 9, wherein the resonant circuit comprises an inductance in parallel with a capacitance, the inductance and the capacitance selected to tune a resonant frequency across the slot to the first frequency, a total inductance across the slot approximating the inductance of the resonant circuit, a total capacitance across the slot including the capacitance of the resonant circuit.
